(19) United States
(12) Patent Application Publication
(10) Pub. No.: US 2010/0061021 A1
(43) Pub. Date: Mar. 11, 2010

(54) STORAGE DEVICE, HEAD SUPPORT MECHANISM AND METHOD OF MANUFACTURING THEREOF

(75) Inventor: Yutaka Kamibayashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/510,820

(22) Filed: Jul. 28, 2009

(30) Foreign Application Priority Data
Sep. 11, 2008 (JP) 2008-233874

(51) Int. Cl. G11B 21/16

(52) U.S. Cl. 360/245.2; G9B/21.023

(57) ABSTRACT

A storage device includes a head that reads and writes data from and to a recording medium and a head support mechanism that supports the head. The head support mechanism includes a first arm member that holds the head, a second arm member that supports the first arm member, a wiring member that has a first end and a second end and includes an extension portion extending toward the second arm member, and a fixing element. The second arm member and the first arm member are joined together at a joint portion. The wiring member is connected with the head at the first end. The extension portion is provided at the second end. The fixing element fixes the extension portion at a position near the joint portion.

### CROSS-REFERENCE TO RELATED APPLICATION

This application is based upon and claims the benefit of priority of the prior Japanese Patent Application No. 2008-233874, filed on Sep. 11, 2008, the entire contents of which are incorporated herein by reference.

### FIELD

The embodiments discussed herein are directed to a storage device, a head support mechanism and a method of manufacturing thereof.

### BACKGROUND

In magnetic disk devices, a position of a magnetic head relative to a magnetic disk is controlled by causing an arm, on which the magnetic head is mounted, to pivot above the magnetic disk. An example of such a magnetic disk device is disclosed in Japanese Laid-open Patent Publication No. 2008-47165. This magnetic disk device includes a magnetic head attached to a leading end of a suspension. The suspension is attached to a carriage arm that is pivotally held.

Another example of such a magnetic disk device is disclosed in Japanese Laid-open Patent Publication No. 2004-335042. This magnetic disk device includes a wiring member, which is in some cases referred to as a long tail. The wiring member extends from the magnetic head attached to the suspension to a carriage arm to be connected with a read/write flexible printed circuit (FPC) arranged on the carriage arm.

An exemplary method for manufacturing the arm will be described. The carriage arm and the suspension are swaged together. The long tail is then inserted into a slit defined in the carriage arm and connected with the read/write FPC. Meanwhile, the long tail is sufficiently long so that the long tail can be inserted into the slit. Accordingly, a part of the long tail near a joint portion, at which the carriage arm and the suspension are waged together, is not fixed and has a relatively high degree of freedom. This part of the long tail is therefore referred to as an elbow portion.

However, when the elbow portion receives air flow produced by the magnetic disk that spins rapidly, the elbow portion can vibrate. The vibrations of the elbow portion exert influence on signal transmission through the long tail, thereby disadvantageously degrading reading/writing performance of the magnetic head.

Meanwhile, higher read/write accuracy has been more increasingly demanded of magnetic disk devices in response to recent increase in spinning speed of magnetic disks associated with increase in storage capacity and transmission speed of magnetic disk devices. Hence, preventing the vibrations of the elbow portion and the performance degradation resulting form the vibrations have been eagerly desired.

### SUMMARY

According to an aspect of an embodiment of the present invention, a storage device includes a head that reads and writes data from and to a recording medium, and a head support mechanism that supports the head. The head support mechanism includes a first arm member that holds the head; a second arm member that has a joint portion and supports the first member, the second arm member and the first arm member being joined together at the joint portion; a wiring member that has a first end and a second end and includes an extension portion that extends toward the second arm member, the wiring member being connected with the head at the first end, the extension portion being provided at the second end; and a fixing element that fixes the extension portion at a position near the joint portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of an arm of a magnetic head according to an embodiment;

FIG. 2 is a schematic configuration diagram of a magnetic disk device according to the embodiment;

FIG. 3 is a schematic diagram for explaining how to assemble a head support mechanism;

FIG. 4 is a graph for explaining how power spectrum is changed by fixation of an elbow portion;

FIG. 5 is a schematic explanatory diagram of an alternative configuration of the head support mechanism that collectively moves a plurality of arms;

FIG. 6 is a flowchart of a part of a method for manufacturing the head support mechanism;

FIG. 7 is a schematic explanatory diagram of a direction in which adhesive is to be applied;

FIG. 8 is a schematic explanatory diagram of amounts of adhesives applied to the arm on a plane parallel to a surface of the arm;

FIG. 9 is an explanatory diagram of an alternative configuration in which only the elbow portion is fixed to the arm with an adhesive;

FIG. 10 is a schematic explanatory diagram of amounts of the adhesives applied to the arm on a plane orthogonal to the surface of the arm;

FIG. 11 is a schematic explanatory diagram of an alternative configuration in which a fixation support member that helps the adhesive to fix the elbow portion to the arm is additionally provided; and

FIG. 12 is a schematic explanatory diagram of an alternative configuration in which the elbow portion is fixed to the arm by using a pawl.

### DESCRIPTION OF EMBODIMENTS

In the following description, a storage device, a head support mechanism and a method of manufacturing thereof according to embodiments are explained in detail with reference to accompanying drawings.

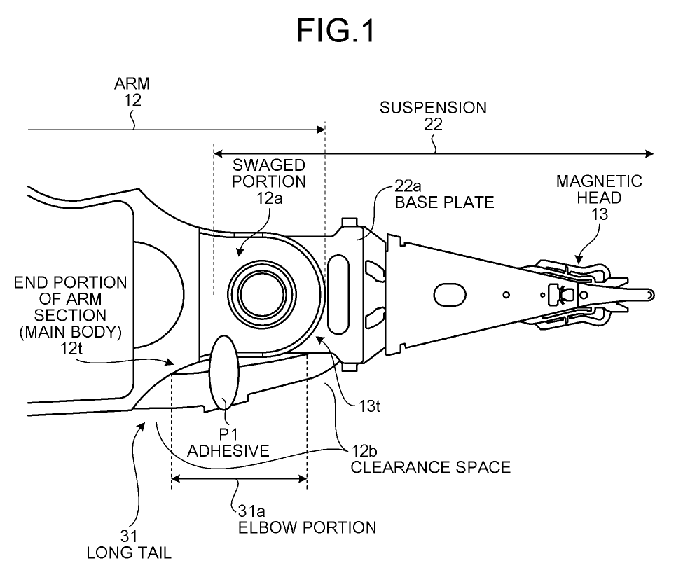

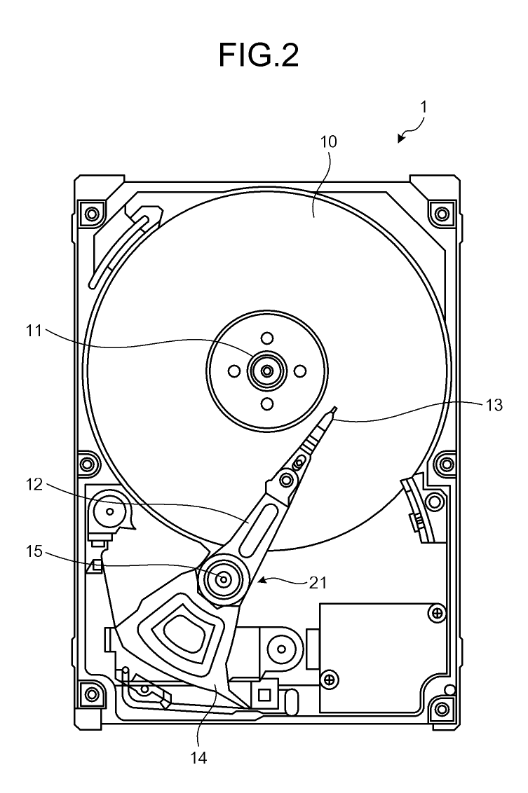

FIG. 1 is a schematic configuration diagram of a magnetic head support mechanism, or an arm 12, according to an embodiment. FIG. 2 is a schematic configuration diagram of a magnetic disk device 1 according to the embodiment.

As depicted in FIG. 2, a spindle motor 11 drives a magnetic disk 10 to spin. A magnetic head 13 attached to a tip end of the arm 12, which is a head support mechanism, reads and writes data from and to the magnetic disk 10. While the magnetic head 13 is kept floating closely over the magnetic disk 10 by lift produced by the magnetic disk 10 that spins, the magnetic head 13 reads and writes data from and to the magnetic disk 10. A voice coil motor (VCM) 14, which is a head drive mechanism, is arranged on a rear end of the arm 12. The VCM 14 drives the arm 12 to pivot about a shaft 15 along an arc locus so that the magnetic head 13 seeks across tracks of the magnetic disk 10 and changes a track to or from which the magnetic head 13 reads or writes data.

More specifically, as depicted in FIG. 1, a suspension 22 is swaged with the tip end of the arm 12 of a carriage 21 that is connected with the VCM 14. The magnetic head 13 is mounted on a leading end of the suspension 22.

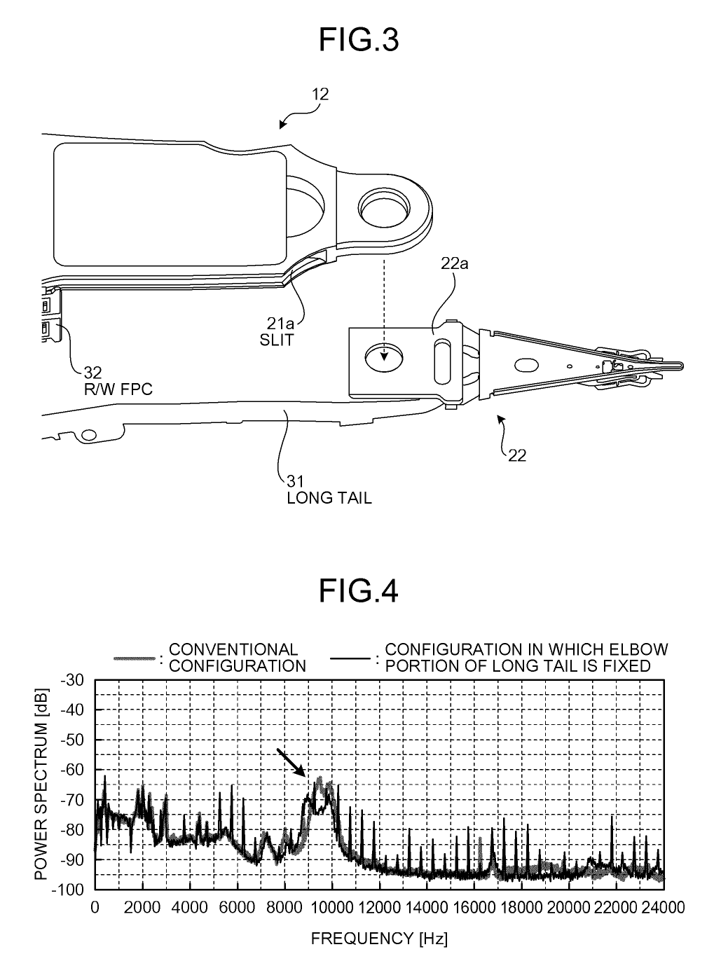

A long tail (extension portion) 31 extends from a wiring member that is connected at one end with the magnetic head 13. The other end of the long tail 31 is arranged on a side surface of the arm 12 of the carriage 21. FIG. 3 is a schematic diagram for explaining how to assemble the arm 12. As depicted in FIG. 3, a slit 21a is defined in the side surface of the arm 12. The long tail 31 is inserted into the slit 21a to be connected with a read/write flexible printed circuit board (R/W FPC) 32. The long tail 31 has a certain degree of freedom so that the long tail 31 can be easily inserted into the slit 21a and connected with the R/W FPC 32. A swaged portion 12a where the arm 12 and the suspension 22 are swaged together is bowl shaped. Because an end portion 12t of an arm section (main body) of the arm 12 is positioned away from an end portion 13t of the suspension 22, a clearance space 12b, which is a space surrounded by the end portion 12t, the end portion 13t, and a side portion of the swaged portion 12a, is provided.

With this arrangement, as depicted in FIG. 1, a portion of the long tail 31 near the swaged portion 12a, which is a joint portion between the arm 12 and the suspension 22, is arranged in the clearance space 12b. Accordingly, this portion of the long tail 31 is not fixed and therefore has a relatively high degree of freedom. This portion is referred to as an elbow portion 31a. More specifically, the elbow portion 31a is away from the swaged portion 12a by a certain distance, e.g., 0.33 millimeter.

In the present embodiment, the elbow portion 31a of the long tail 31 is fixed (to the arm 12) with an adhesive. Accordingly, even while the magnetic disk 10 is spinning rapidly, it is possible to suppress vibrations of the elbow portion 31a that are generated by an air flow produced by the magnetic disk 10. Hence, performance degradation of the magnetic head 13 resulting from the vibrations can be prevented.

FIG. 4 is a graph for explaining how power spectrum is changed by fixation of the elbow portion 31a. As depicted in FIG. 4, the power gain is −65 decibels at 9,500 hertz when the elbow portion is not fixed while the power gain decreases to a level as low as −70 decibels when the elbow portion is fixed.

How to fix the elbow portion 31a with an adhesive will be described. As depicted in FIG. 1, the arm 12 and a base plate 22a of the suspension 22 is swaged together. After the long tail 31 is inserted into the slit 21a, the adhesive is applied to an adhesive fixing portion P1 near the swaged portion 12a. The thus-applied adhesive hardens to function as a fixing element and fix the elbow portion 31a to the arm 12.

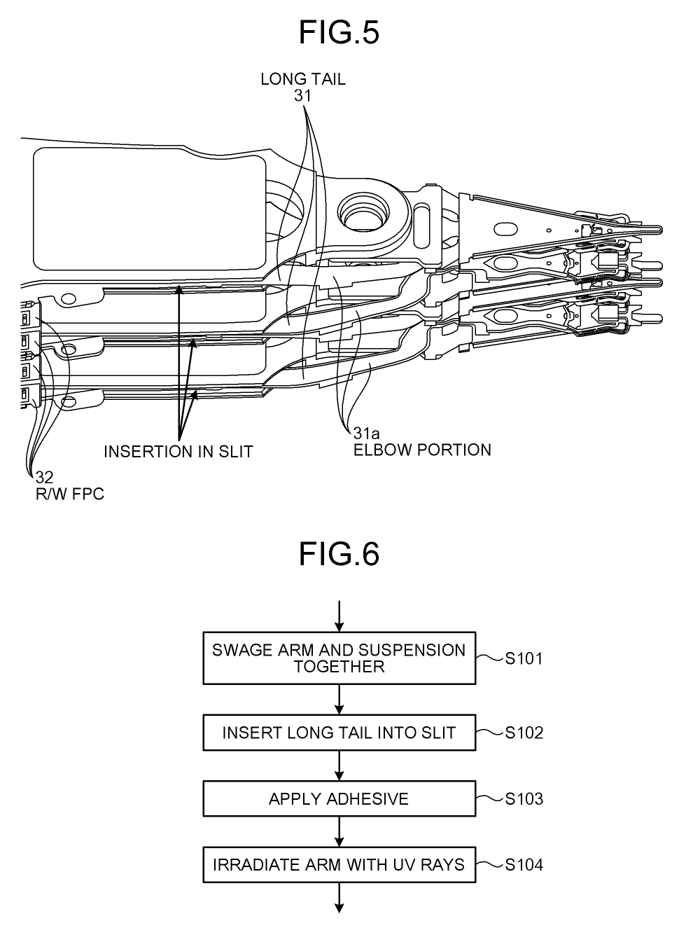

FIG. 5 is a schematic explanatory diagram of an alternative configuration. With this modification, the head support mechanism collectively moves a plurality of arms that are attached to the VCM 14. As with the configuration discussed above, it is possible to suppress vibrations of elbow portions by fixing each of the elbow portions at a position near a swaged portion of a corresponding one of the arms with this modification.

A method for manufacturing the head support mechanism according to the present embodiment will be described with reference to FIG. 6. The arm 12 is manufactured by sequentially performing a plurality of processes. The processes can be performed by a single apparatus or a plurality of different apparatuses. Key processes for the present embodiment among the processes for manufacturing the head support mechanism are depicted in FIG. 6.

As depicted in FIG. 6, after a preceding process has been completed, a manufacturing apparatus swages the arm 12 and the suspension 22 together (Step S101). Thereafter, the long tail 31 is inserted into the slit 21a (Step S102). Then, application of an adhesive is performed (Step S103). The adhesive is preferably a high-viscosity adhesive that hardens under irradiation of ultraviolet (UV) rays. The applied adhesive is irradiated with UV rays for approximately 30 seconds (Step S104) to be hardened. Thereafter, the head support mechanism is fed to a subsequent process.

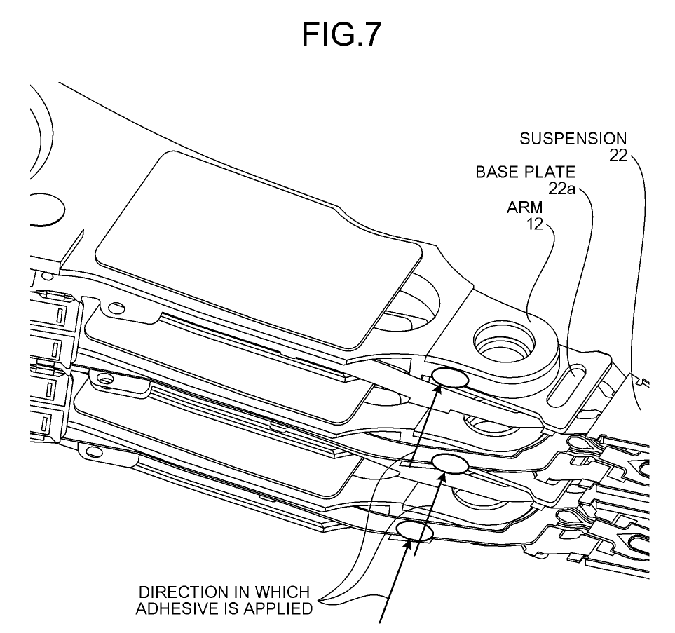

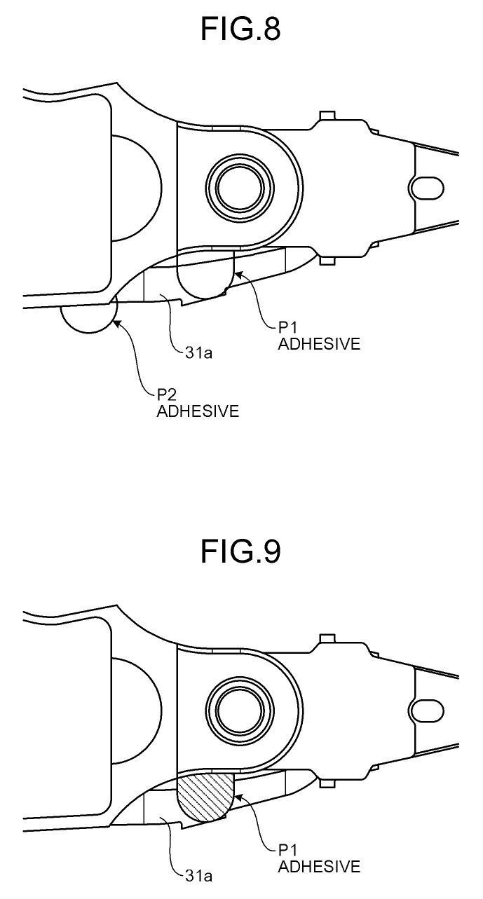

FIG. 7 is a schematic diagram for explaining a direction in which the adhesive is to be applied. As depicted in FIG. 7, the adhesive is preferably applied in a lateral direction (from a side portion of the arm 12) relative to the arm 12. FIG. 8 is a schematic diagram for explaining amounts of adhesives to be applied to the arm 12 on a plane parallel to the surface of the arm 12. As depicted in FIG. 8, the amount of the adhesive on the above plane is preferably set such that the adhesive P1 bonds the long tail 31 and the swaged portion 12a together across the clearance defined by the elbow portion 31a.

The adhesive P2 depicted in FIG. 8 bonds the long tail 31 at an insertion portion where the long tail 31 is inserted into the slit 21a. The long tail 31 has conventionally been fixed to the arm 12 in this manner by applying the adhesive P2 only at the insertion portion. Such a conventional fixation scheme prevents unintentional coming off of the long tail 31 from the slit 21a; however, has failed to suppress vibrations of the elbow portion 31a. To this end, the adhesive P1 is applied to the elbow portion 31a in addition to a portion where the adhesive P2 has conventionally been applied as depicted in FIG. 8, or in place of the insertion portion of slit 21a as depicted in FIG. 9. By applying the adhesive P1 in this manner, vibrations of the long tail 31 can be suppressed.

Put another way, according to the present embodiment, the adhesive P1 is applied in addition to the portion where an adhesive has conventionally been applied or in place of the portion, thereby suppressing vibrations of the long tail 31. This configuration improves properties (high-speed access capability (seeking performance/tracking performance) and recording/writing performance) of the magnetic head 13.

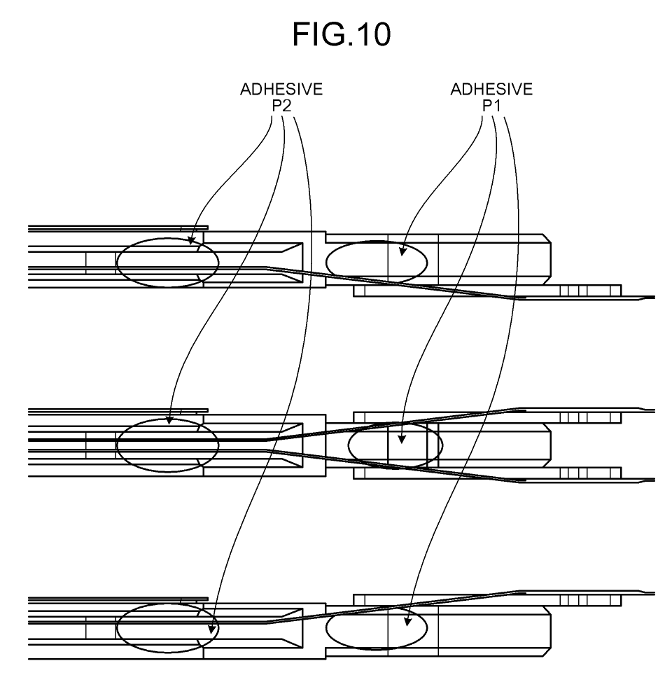

FIG. 10 is a schematic explanatory diagram of amounts of the adhesives P1 and P2 to be applied to the arm 12 in a thickness direction of the arm 12. As depicted in FIG. 10, each of the amount of the adhesive P1 and that of the adhesive P2 is preferably set such that the thickness of the adhesive P1 and that of the adhesive P2 on the arm 12 are smaller than the thickness of the arm 12.

By manufacturing the head support mechanism in this manner, such that the arm 12 and the suspension 22 are swaged together, the long tail 31 is inserted into the slit 21a, and then the elbow portion 31a is fixed to the arm 12 with the adhesive, the vibrations of the long tail 31 can be suppressed. This improves properties of the magnetic head 13. It is possible to fix the long tail 31 to the arm 12 with the adhesive in advance and then swage the arm 12 and the suspension 22 together. However, in this case, the degree of freedom of the thus-swaged long tail 31 is smaller than that of the not-yet-fixed long tail 31. This lower degree of freedom makes it less easy to insert the long tail 31 into the slit 21a and connect the long tail 31 to the R/W FPC 32. Accordingly, it is preferable to fix the long tail 31 to the arm 12 after the long tail 31 has been swaged with the arm 12.

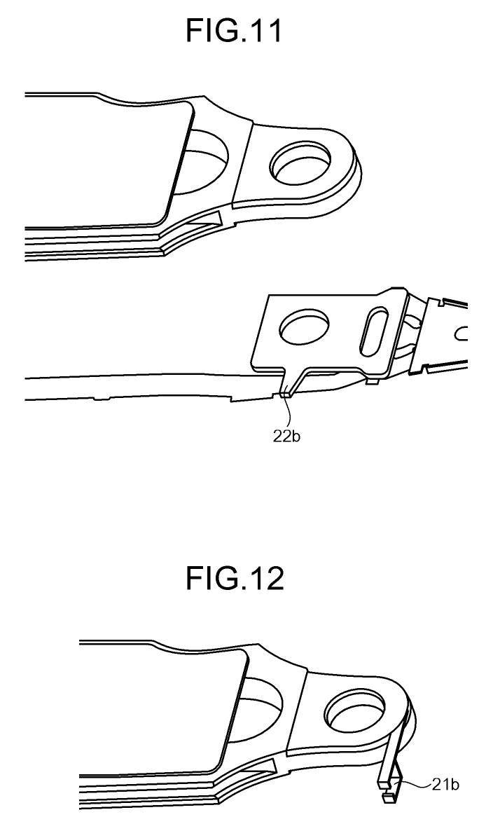

FIG. 11 is a schematic explanatory diagram of an alternative configuration in which a fixation support member is additionally provided. The fixation support member helps the adhesive P1 to fix the elbow portion 31a. With the configuration depicted in FIG. 11, a protrusion 22b corresponding to the fixation support member extends from the base plate 22a toward the long tail 31. The adhesive can fix the long tail 31 more securely by being applied to a position near the protrusion 22b. FIG. 11 depicts the example in which the protrusion 22b is arranged on the base plate 22a; however, a protrusion can be arranged on the arm 12 or a fitting for use in swaging rather than on the base plate 22a.

FIG. 12 is a schematic explanatory diagram of an alternative configuration in which the arm 12 additionally includes a pawl 21b that fixes the elbow portion 31a. With this modification that structurally fix the elbow portion 31a by using the pawl 21b, the need of fixing the elbow portion 31a with the adhesive can be eliminated. FIG. 12 depicts the example in which the pawl 21b is arranged on the arm 12; however, a pawl can be arranged on the suspension 22 or a metal fitting for use in swaging.

In this manner, the magnetic disk device 1 according to the embodiments is manufactured such that after the arm 12 and the suspension 22 are swaged together, the elbow portion 31a of the long tail 31 is fixed to the arm 12 with the adhesive P1. Accordingly, the vibrations of the long tail 31 can be suppressed, which improves read/write performance and high-speed access capability of the magnetic head 13.

A storage device, a head support mechanism, and a method of manufacturing thereof according to the embodiments disclosed herein advantageously suppress vibrations of an elbow portion, thereby improving read/write performance.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A storage device comprising:
a head that reads and writes data from and to a recording medium; and
a head support mechanism that supports the head, the head support mechanism comprising:
a first arm member that holds the head;
a second arm member that has a joint portion and supports the first member, the second arm member and the first arm member being joined together at the joint portion;
a wiring member that has a first end and a second end and includes an extension portion that extends toward the second arm member, the wiring member being connected with the head at the first end, the extension portion being provided at the second end; and
a fixing element that fixes the extension portion at a position near the joint portion.

2. The storage device according to claim 1, wherein the fixing element is an adhesive.

3. The storage device according to claim 2, wherein the adhesive is applied to the position near the joint portion and a position where the wiring member is in contact with the second arm member.

4. The storage device according to claim 1, wherein the first arm member and the second arm member are joined together by swaging.

5. The storage device according to claim 1, wherein the second arm member includes a slit to receive the wiring member inserted thereinto.

6. A head support mechanism for supporting a head that reads and writes data from and to a recording medium, the head support mechanism comprising:
a first arm member that holds the head;
a second arm member that has a joint portion and supports the first member, the second arm member and the first arm member being joined together at the joint portion;
a wiring member that has a first end and a second end and includes an extension portion that extends toward the second arm member, the wiring member being connected with the head at the first end, the extension portion being provided at the second end; and
a fixing element that fixes the extension portion at a position near the joint portion.

7. A method for manufacturing a head support mechanism that holds a head that reads and writes data from and to a recording medium, the method comprising:
joining a first arm member that holds the head and a second arm member that supports the first arm member together at a joint portion;
inserting a wiring member into a slit defined in the second arm member, the wiring member having a first end, at which the wiring member is connected with the head, and a second end, at which the wiring member is inserted into the slit; and
fixing the wiring member at a position near the joint portion.
